(19) United States
(12) Patent Application Publication
(10) Pub. No.: US 2015/0260824 A1
(43) Pub. Date: Sep. 17, 2015

(54) UNMANNED AERIAL SYSTEM DRONE SITUATIONAL AWARENESS FLIGHT SAFETY AND TRACKING SYSTEM

(71) Applicant: Chester Charles Malveaux, Baton Rouge, LA (US)

(72) Inventor: Chester Charles Malveaux, Baton Rouge, LA (US)

(21) Appl. No.: 14/210,219

(22) Filed: Mar. 13, 2014

(51) Int. Cl. G01S 1/70; B64D 45/00; H04Q 11/00; G01S 1/08

(52) U.S. Cl. CPC G01S 1/70; G01S 1/08; B64D 45/00; H04Q 11/00

(57) ABSTRACT

The invention provides for the creation of an electromagnetic wave broadcast based locator beacon systems to allow for the tracking of drone/UAV/UAS, hereafter also referred to as drones, coupled with an alert system and display panel which can be placed in manned aircraft and other locations to let pilots and concerned parties know when they are in the vicinity of each other and or when drone aircraft are operating nearby any areas of concern utilizing this system. This system will alert pilots and others when a drone is operating in their area as well as give an indication of the drone's proximity to their aircraft while also allowing drone operators to know where manned aircraft and other operators using the system are located. This invention will allow concerned parties to maintain situational awareness and avoid operational incursions while also providing enhanced safety through increased situational awareness.

### CROSS-REFERENCE TO RELATED APPLICATIONS

Not Applicable

### STATEMENT REGARDING FEDERALLY SPONSORED RESEARCH FOR DEVELOPMENT

Not Applicable

### REFERENCE TO SEQUENCE LISTING

Not Applicable

### BACKGROUND OF THE INVENTION

Transponders capable of helping control towers and other interested parties locate and track aircraft have been around for many years. Systems similar to these can be used to track objects of interest. In the aviation industry situational awareness is crucial to effective and safe operations. Recent advances in technology have made it possible for public and private drone aircraft to be operated in or near airspace occupied by manned aircraft; as such a safety system is needed to alert pilots and drone operators as to when they are in the vicinity of each other so as to avoid collisions and airspace incursions. This invention can apply electromagnetic wave communications, telemetry, and tracking technology to making it possible for pilots of manned aircraft and other concerned parties to know when drones are operating within their vicinity and also to alert drone pilots as to aircraft operating near their area of operation.

### BRIEF SUMMARY OF THE INVENTION

This invention involves the creation of radio and other electromagnetic frequency based locator beacon systems to allow for the tracking of drone/UAV/UAS aircraft, hereafter also referred to simply as drones, coupled with an alert system and display panel which can be placed in manned aircraft and also obtained by drone operators to let pilots of drones and manned aircraft along with other concerned parties know when they are in the vicinity of each other and or when drone aircraft are operating nearby any concerned party utilizing the drone tracking and alert system hereby envisioned. This system will alert pilots when a drone is operating in their area as well as give an indication of the drone's proximity to their aircraft while also allowing drone operators to know where manned aircraft and fixed based and mobile ground or water based operators using the system are located. Drone operators can be alerted by corresponding transponders available for installation on manned aircraft and fixed and mobile bases of operations as part of the system. This invention will allow drone operators as well as pilots of manned aircraft and other concerned parties to have situational awareness of each other during all phases of flight operations.

For security personnel, and other concerned parties, this device can allow them to be aware of drone aircraft operating in their vicinity. This situational awareness can increase safety on the ground as well as in the airspace while also allowing drone operations to be monitored.

Some models of the system will be capable of logging and transmitting real time telemetry data on drone aircraft. In this way pilots and other concerned parties can be made aware of the position altitude and heading of drone aircraft so as to avoid airspace incursions and increase situational awareness and safety.

For security, first response, emergency preparedness, other concerned parties, and governmental operations the speed and position of drone aircraft can be tracked. Gps data will also allow full situational awareness as to the position and activities of drones with each drone having a unique radio signal operational I.D. Real time streaming of this data as well as logging will allow for historical study of actions and allow for analysis of drone operations in an area.

It is, therefore, desirable to provide this system to give real time situational awareness and historical logs of drone activities in an area for the purposes of increased safety during drone operations.

### BRIEF DESCRIPTION OF THE SEVERAL VIEWS OF THE DRAWING

FIG. 1 is a top view of an embodiment of the drone mounted portion of the drone situational awareness system showing the outline of circuit boards containing the sensors, cpu, data storage, and transmitter. The microcontroller system is visible at the center of the figure and is represented as a smaller rectangle held within a larger rectangle which is the main circuit board which holds the cpu along with other components of the system. The GPS is represented by a concentric circle in the upper left hand corner of FIG. 1. In the upper right hand corner of FIG. 1 the diamond shape represents the units wireless data transmitter and antenna. Three arrows directly to the right of the microcontroller represent the unit's onboard 3 axis accelerometer. Four arrows to the left of the microcontroller represent the unit's magnetometer. In the lower left hand corner of the figure the rectangle represents the interface between the unit and the onboard inertial management unit of the drone aircraft. In the lower right hand corner of the figure a smaller rectangle represents the connector for an external GPS unit. Also in the lower right hand corner of FIG. 1 the pictured hexagon represents onboard data storage.

FIG. 2 is a top view of an embodiment of the aircraft and ground station mounted portion of the drone situational awareness system showing the outline of circuit boards containing the sensors, cpu, data storage, and transmitter. The microcontroller system is visible at the center of the figure and is represented as a smaller rectangle held within a larger rectangle which is the main circuit board which holds the cpu along with other components of the system. The GPS is represented by a concentric circle in the upper left hand corner of FIG. 2. In the upper right hand corner of FIG. 1 the diamond shape represents the units wireless data transmitter and antenna. Three arrows directly to the right of the microcontroller represent the unit's onboard 3 axis accelerometer. Four arrows to the left of the microcontroller represent the unit's magnetometer. In the lower left hand corner of the figure the rectangle represents the interface between the unit and its display panel. Directly above the microcontroller the rectangle represents a connection for an external GPS. In the lower right hand corner of FIG. 2 the pictured hexagon represents onboard data storage.

FIG. 3 is a frontal view of the display panel for the aircraft or ground station mounted portion of the drone situational awareness system showing the outline of the display panel as a large rectangle with installed components. At the center of the panel the rectangle represents the display screen of the panel. At the lower left hand corner of the panel two concentric circles represent the control knob for the device which allows activation and changes to display settings. At the upper left hand corner the single circle represents the display panels multicolor flashing indicator light which indicates the proximity of a drone with increased flashing rate and color changes as drones get nearer to aircraft or ground stations with this system installed.

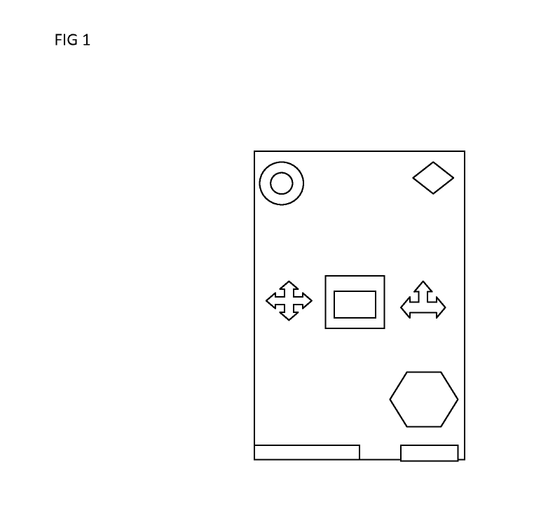

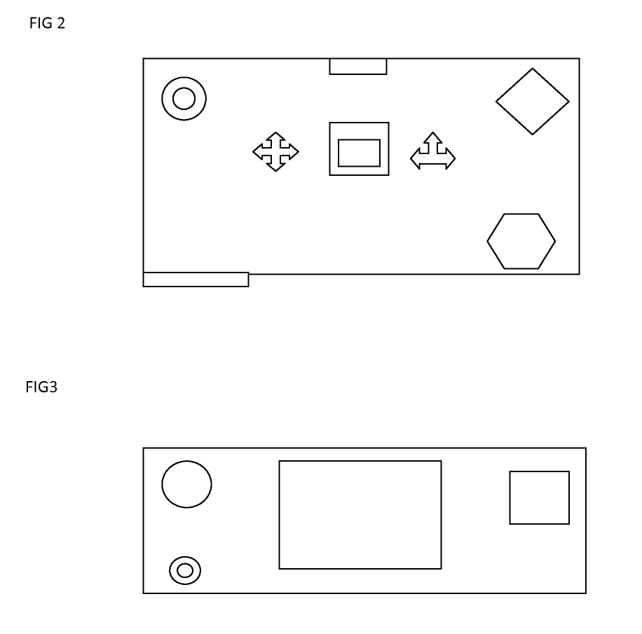

### DETAILED DESCRIPTION OF THE INVENTION

The present invention relates generally to a safety system which allows pilots of manned aircraft and other concerned individuals to be aware of drones operating in their vicinity and also alert unmanned aerial system operators, also referred to as operators of drone aircraft or operators of UAV's, to manned aircraft in their area of operations. More particularly, the present invention relates to a system which will consist of radio transmission and telemetry equipment mounted on drone aircraft along with radio telemetry and transmission equipment which can be installed on manned aircraft along with receiver and tracking units on manned aircraft as well as configured as ground stations which will allow for the operators of drones, manned aircraft, and other concerned parties to maintain situational awareness of drone operations in their vicinity. This system will aid in helping pilots and drone operators avoid collisions and airspace incursions while also helping concerned parties on the ground manage activities in respect of drone operations in their area.

The best mode for carrying out the invention is provided by using unique and novel combinations of existing microcontroller, sensor radio telemetry, gps, and receiver technology. Fabrication of light weight and water proof housings for sensors and transmitters is readily available. Current wireless modem technology, radio receiver and transmission technology, as well as radio beacon, and data transmission security features are sufficient to be applied to the applications of this device. Computer aided design and 3D printing technology makes this device readily buildable.

Radio telemetry and tracking systems have been around for a long time, but unique and novel systems as proposed by this invention for allowing full situational awareness pertaining to the operation of drone aircraft have not existed. This system will apply radio signal, telemetry, and tracking technology to drones and make it possible for pilots of manned aircraft to know when drones are operating within their vicinity and also to alert drone pilots as to aircraft operating near their area of operation as well as inform other concerned parties.

What is claimed is:

1. A drone/UAV/UAS, tracking beacon and location system which will allow these automated and remotely piloted aircraft to be tracked giving situational and geospatial awareness of drone operations to pilots of manned aircraft and other concerned parties.

2. A drone/UAV/UAS tracking beacon and location system of claim 1 which can also alert drone operators to the presence of manned aircraft which have the system installed onboard.

3. A drone/UAV/UAS tracking beacon and location system receiver which on some models have an imbedded tracking and location beacon on the receiver units of ground stations and units installed in aircraft which will also give the locations of aircraft and ground stations who are using the system and turn on their remote trackers so as to provide their geospatial location for the increased safety and situational awareness of all concerned parties.

4. A drone/UAV/UAS tracking beacon and location system of claim 1 which has onboard gps, magnetometer, and 3 axis accelerometer along with interfaces to drone/UAV/UAS onboard inertial management unit and guidance system, onboard memory in its microcontroller along with electromagnetic wave and or radio wave transmission equipment so as to record and transmit UAV geospatial position and movement vector information to a receiver system installed in aircraft and ground stations.

5. A drone/UAV/UAS tracking beacon and location system of claim 1 which interfaces with the inertial management unit of a drone on which it is installed so as to log its geospatial position, speed, and other telemetry data so as to make this information available to users of the drone tracking and locating system as described by this invention.

6. A drone/UAV/UAS tracking beacon and location system of claim 1 with an indicator light which indicates the proximity of a drone with increased flashing rate and color changes as drones get nearer to aircraft or ground stations with the system installed.

7. A drone/UAV/UAS tracking beacon and location system of claim 1 in which a multifunction display shows the position and other telemetry data of drone aircraft in the vicinity of a ground station or aircraft in which the display and receiver portion of this drone monitoring and alert system is installed.

8. A drone/UAV/UAS tracking beacon and location system of claim 1 in which high powered radio telemetry systems and radio modems onboard unmanned aircraft transmit data as to the drones geospatial position, altitude, heading, speed, and other flight parameters to receivers on manned aircraft with the system installed as well as to ground station receivers so as to allow operators of manned aircraft and ground station to maintain full situational awareness of drone operations in their vicinity so as to avoid airspace and operational space incursions.

9. A drone/UAV/UAS tracking beacon and location system of claim 3 in which high powered radio telemetry systems and radio modems are integrated as part of the drone/UAV/UAS tracking beacon and location system's receiver unit installed on aircraft or at mobile or fixed base stations so as to transmit data as to the position, altitude, heading, speed, and other telemetric parameters of the receiver system and its installation area to other receivers used by drone operators, pilots, and other concerned parties with the system installed at their location, vehicle, or aircraft so as to allow the operators of receiver units to maintain full situational awareness of manned aircraft operations in their vicinity and as well as other operators so as to avoid airspace or work site incursions.

10. A drone/UAV/UAS tracking beacon and location system of claim 1 in which onboard data storage logs geospatial, temporal, altitude, heading, speed, and other telemetric parameters on drone based units and base stations so as to create a record of operations and locations in which the system was operated.

11. A drone/UAV/UAS tracking beacon and location system of claim 1 which on some models can be made compatible with existing air traffic control networks systems so as to be integrated with current air traffic control systems and networks.
